(19) United States
(12) Patent Application Publication
(10) Pub. No.: US 2020/0380653 A1
(43) Pub. Date: Dec. 3, 2020

(54) IMAGE PROCESSING DEVICE AND IMAGE PROCESSING METHOD

(71) Applicant: KABUSHIKI KAISHA TOSHIBA, Tokyo (JP)

(72) Inventors: Akiyuki TANIZAWA, Kawasaki Kanagawa (JP); Saori ASAKA, Yokohama Kanagawa (JP)

(73) Assignee: KABUSHIKI KAISHA TOSHIBA, Tokyo (JP)

(21) Appl. No.: 16/810,063

(22) Filed: Mar. 5, 2020

(30) Foreign Application Priority Data
May 31, 2019 (JP) 2019-102264

(51) Int. Cl. G06T 7/00; G06T 7/62; G06T 7/90; G06T 7/50

(52) U.S. Cl. CPC G06T 7/001; G06T 7/62; G06T 2207/30136; G06T 7/50; G06T 7/90

(57) ABSTRACT

According to one embodiment, an electronic device includes one or more processors. The one or more processors are configured to acquire a first image and an optical parameter of a camera that captures the first image, the first image including an object, and calculate an area of a partial region of the object by using the first image and the parameter.

### CROSS-REFERENCE TO RELATED APPLICATIONS

This application is based upon and claims the benefit of priority from Japanese Patent Application No. 2019-102264, filed May 31, 2019, the entire contents of which are incorporated herein by reference.

### FIELD

Embodiments described herein relate generally to an image processing device and an image processing method.

### BACKGROUND

When the state of an actual object is to be judged, it is sometimes judged based on an image instead of the actual object. An example thereof is an inspection for maintenance of infrastructure facilities. For example, there is a deterioration diagnosis device for inspecting aging changes, etc., of steel materials of power transmission facilities. This device is an image processing device that evaluates deterioration levels of steel materials according to color images including the steel materials of steel towers. The device derives deterioration characteristics of the steel materials from evaluation timings of deterioration levels and evaluation values of the deterioration levels. The device generates a maintenance schedule of the steel materials based on the deterioration characteristics.

The size of a steel material in an image is varied depending on optical camera parameters such as an image capturing distance, a sensor size, etc. Therefore, conventional image processing devices for deterioration diagnosis were not able to calculate the area of a photographic subject captured in an image.

### BRIEF DESCRIPTION OF THE DRAWINGS

FIG. 1 is a block diagram showing an example of an entire system configuration including an image processing device of a first embodiment.

FIGS. 2A, 2B, and 2C are the drawings showing an image capturing principle of an image capturing device in the system according to the first embodiment.

FIG. 3 is a diagram showing an example of a module configuration of a deterioration-area calculating program included in the image processing device according to the first embodiment.

FIGS. 4A, 4B, 4C, and 4D are diagrams showing examples of a captured image, a depth image, an extracted image, and a deterioration image.

FIG. 5 is a diagram showing an example of deterioration-area data.

FIG. 6 is a diagram showing an example of a captured image, in which an image including two inspection objects at different distances from a camera is captured.

FIGS. 7A and 7B are diagrams showing examples of deterioration-area data of each of two inspection objects included in the captured image of FIG. 6.

FIG. 8 is a flow chart showing an example of a processing flow of a deterioration-area calculating program.

FIG. 9 is a diagram showing a configuration example of a region extracting module.

FIG. 10 is a flow chart showing an example of a processing flow of the region extracting module.

FIG. 11 is a diagram showing a configuration example of a deterioration detecting module.

FIG. 12 is a flow chart showing an example of a processing flow of the deterioration detecting module.

FIG. 13 is a diagram showing a configuration example of a deterioration-area calculating module.

FIG. 14 is a diagram showing a principle of pixel size calculations.

FIG. 15 is a diagram showing an example of processing of a pixel-size calculating module.

FIG. 16 is a diagram showing an example of processing of a pixel-area calculating module.

FIG. 17 is a flow chart showing an example of a processing flow of the deterioration-area calculating module.

FIG. 18 is a diagram showing an example of a module configuration of a deterioration-area calculating program included in an image processing device according to a second embodiment.

FIG. 19 is a diagram showing an example of a module configuration of a deterioration-area calculating program included in an image processing device according to a third embodiment.

FIG. 20 is a diagram showing an example of repair data input to the image processing device according to the third embodiment.

FIG. 21 is a diagram showing an example of repair priority data output from the image processing device according to the third embodiment.

FIG. 22 is a flow chart showing an example of a processing flow of a module configuration of the deterioration-area calculating program according to the third embodiment.

### DETAILED DESCRIPTION

Hereinafter, embodiments will be described with reference to the drawings. Following descriptions show examples of the devices and methods for realizing technical ideas of the embodiments, and the technical ideas of the embodiments are not limited to the structures, shapes, layouts, materials, etc., of below described constituent elements. As a matter of course, modifications easily conceivable by those skilled in the art fall within the scope of this disclosure. In order to elucidate descriptions, the sizes, thicknesses, planar dimensions, shapes, etc., of elements may be schematically shown in drawings with changes made from actual aspects. A plurality of the drawings may include the elements having mutually different dimensional relations or rates. In a plurality of the drawings, corresponding elements may be denoted by the same reference numerals to omit redundant descriptions. Some elements may be referred to by a plurality of names, but such names are merely examples, and it does not deny usage of other names for those elements. The elements that are not referred to by a plurality of names may also be referred to by other names. Note that, in the following description, “connection” does not only mean direct connection, but also means connection via other elements.

In general, according to one embodiment, an image processing device includes one or more processors. The one or more processors are configured to input a first image and an optical parameter of a camera that captures the first image, the first image including an object, and calculate an area of a partial region of the object by using the first image and the parameter.

### First Embodiment

[System Configuration]

Embodiments are applied to image processing devices that obtain the areas of various objects. An image processing device for inspections of infrastructure facilities will be described as a first embodiment. Examples of the infrastructure facilities include buildings, steel towers, windmills, bridges, chemical plants, and power generation facilities. Image processing for inspecting steel towers will be described in the embodiments.

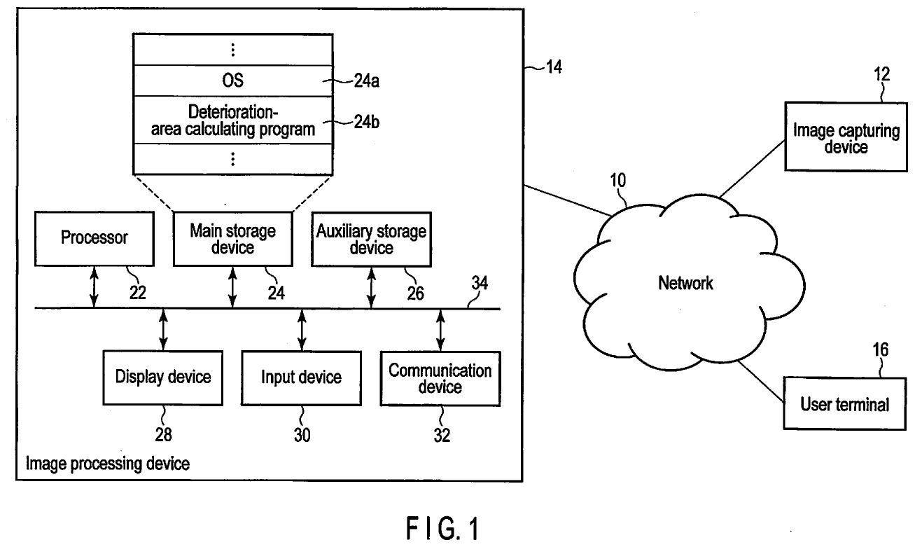

FIG. 1 is a block diagram showing an example of an entire system configuration including the image processing device of the first embodiment. A system includes an image capturing device 12, an image processing device 14, and a user terminal 16 that are connected to a network 10 such as the Internet.

The image capturing device 12 captures images of inspection objects and outputs color images that include the inspection objects. In the embodiment, the information of the depth to the inspection object is required in addition to image information in order to obtain the area (actual physical area) of deteriorated regions of the inspection object.

A stereo camera capable of acquiring an RGB color image and depth information that shows the depth of each pixel, at the same time may be used as the image capturing device 12. When position adjustment processing is carried out for captured stereo images, the stereo camera can calculate the depth from the distance between the lenses of the stereo camera determined in advance.

When a monocular camera that acquires RGB color images is used as the image capturing device 12, the depth information may be obtained by another device. As an example, the depth information can be obtained by irradiating an inspection object with a laser from a position near the camera. Since the image capturing positions of the camera and the laser do not match in such a case, either the color image obtained by the camera or the point group data of the inspection object obtained by the laser have to be corrected by calibration. The calibration may include correcting the image data and the point group data by matching of image capturing coordinates (calculating the amount of misalignment in image capturing positions and correct the color image side or the point group data side with the misalignment amount). The calibration may also include matching of the color images and the point group data (adjusting the positions of the images and the point group per se). As another example, the depth information may be obtained by using a sensor of a TOF (Time Of Flight) measuring type.

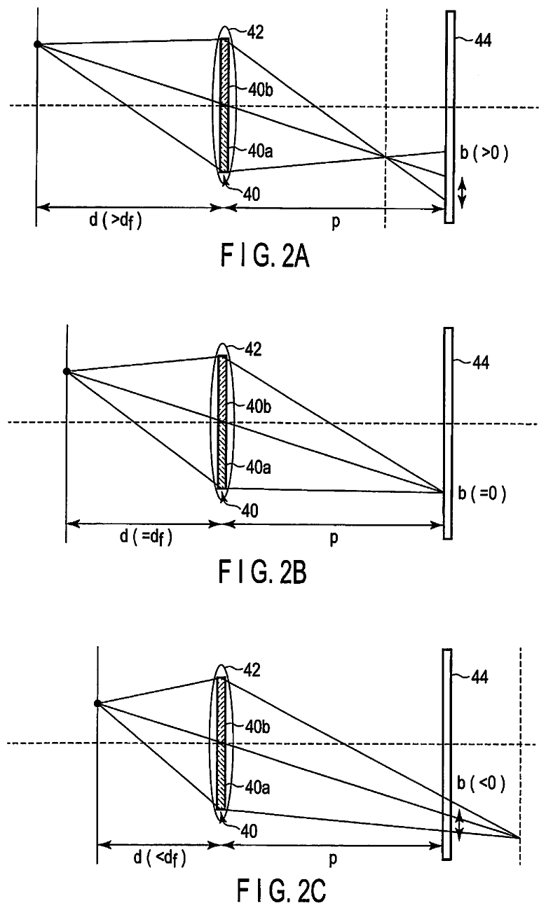

Furthermore, in another example, a camera utilizing the color aperture described in JP 2017-040642 A may be used as the image capturing device 12. As the first embodiment, an example using such a camera will be described. FIGS. 2A to 2C show the image capturing principle of the image capturing device 12 using the color aperture. FIG. 2A shows an optical path in a case where a photographic subject is beyond a focal position (the distance “d” to the photographic subject >the distance “d_{f}” to the focal point). FIG. 2B shows an optical path in a case where the photographic subject is at the focal position (d=d_{f}). FIG. 2C shows an optical path in a case where the photographic subject is closer than the focal position (d<d_{f}).

The image capturing device 12 includes a monocular lens camera, and a filter 40 having transmission characteristics of different wavelength ranges is disposed at an aperture of a lens 42. The distance from the lens 42 to an image capturing surface of an image sensor 44 is represented by “p”. The filter 40 is circular and includes a first filter region 40a and a second filter region 40b that divide the entirety thereof by a straight line passing through the center of the circle. In the example of FIGS. 2A to 2C, the circular filter 40 is divided by a horizontal line into two, an upper side and a lower side. The first filter region 40a includes, for example, a yellow filter that allows the light in the red and green wavelength ranges to transmit therethrough. The second filter region 40b includes, for example, a cyan filter that allows the light in the green and blue wavelength ranges to transmit therethrough.

If the photographic subject is at the focal position, as shown in FIG. 2B, the light ray passing through the center of the filter 40 and the light ray passing through the rim of the filter 40 converges to one point on the image capturing surface of the image sensor 44 (b=0). If the photographic subject is not at the focal position, the light ray that has passed through the first filter region 40a becomes a yellow blur, and the light ray that has passed through the second filter region 40b becomes a cyan blur. As shown in FIG. 2A and FIG. 2C, the directions in which the yellow blur and the cyan blur appear on the image capturing surface of the image sensor 44 are opposite in the case where the photographic subject is beyond the focal position and in the case where the photographic subject is closer (b>0 or b<0). The sizes of the yellow blur and the cyan blur correspond to the distance “d” between the lens 42 and the photographic subject. Therefore, the states of FIG. 2A and FIG. 2C can be discriminated based on the yellow blur and the cyan blur in the image data output from the image sensor 44. Depth information corresponding to the distance “d” to the photographic subject can be obtained from the shapes of the blurs.

Note that, instead of disposing the filter 40 at a lens aperture, the filter 40 may be disposed on the optical path of the light ray that enters the image sensor 44 and the lens 42 may be disposed between the filter 40 and the image sensor 44. Alternately, the filter 40 may be disposed between the lens 42 and the image sensor 44. Furthermore, if the lens 42 includes a plurality of lenses, the filter 40 may be disposed between any two lenses 42. In addition, instead of the yellow filter or the cyan filter, a magenta filter that allows transmission of the light of red and blue wavelength ranges. In addition, the number to divide the region of the filter 40 is not limited to two, but may be three or more. The shapes of the divided regions are not limited to the configuration in which the circle is divided by the straight line passing through the center, but may be a configuration in which the circle is divided into a plurality of regions of a mosaic pattern.

Returning to descriptions about FIG. 1, the image data output from the image capturing device 12 is input to the image processing device 14 via the network 10. As well as a general personal computer, the image processing device 14 includes a processor 22, a main storage device 24, an auxiliary storage device 26, a display device 28, an input device 30, and a communication device 32. The processor 22, the main storage device 24, the auxiliary storage device 26, the display device 28, the input device 30, and the communication device 32 are connected to a bus line 34.

The processor 22 includes, for example, a CPU (Central Processing Unit) and controls operation of the image processing device 14. The auxiliary storage device 26 includes non-volatile storage devices such as a Hard Disk Drive (HDD), a Solid State Drive (SSD), and a memory card and stores programs to be executed by the processor 22. The main storage device 24 includes memories such as a Read Only Memory (ROM) and a Random Access Memory (RAM). The RAM is generally realized by a volatile DRAM or the like and stores the programs read from the auxiliary storage device 26. The processor 22 executes the programs read from the auxiliary storage device 26 into the main storage device 24.

The programs include an operating system (OS) 24a , a deterioration-area calculating program 24b , etc. The programs may be provided to the image processing device 14 as files in installable styles or executable styles recorded in a computer-readable storage media such as CD-ROMs, memory cards, CD-R, and Digital Versatile Discs (DVDs). Alternatively, the programs may be provided in a form that the programs are installed in the image processing device 14 in advance. Note that, instead of storing the programs in the auxiliary storage device 26, the programs may be configured to be provided to the image processing device 14 by storing the programs in a computer, a server, or the like connected to the network 10 and downloading the programs via the network 10. Furthermore, the programs may be stored in a computer, a server, or the like connected to the network 10, and the programs may be configured to be executed without downloading the programs.

The display device 28 includes, for example, a Graphic Processing Unit (GPU) or the like, generates display data of images, areas, etc., and transmits the display data to a display unit such as a liquid-crystal display device. The display unit may be provided outside the image processing device 14 or may be provided in the image processing device 14. The display unit provided outside the image processing device 14 may be a display unit of the user terminal 16. The input device 30 includes, for example, a keyboard, a mouse, etc., and is an input interface for operating the image processing device 14. If the image processing device 14 is a device such as a smartphone or a tablet terminal, the display device 28 and the input device 30 includes, for example, a touch screen. The communication device 32 is an interface for communicating with other devices and is connected to the network 10.

Examples of the user terminal 16 include a general personal computer, a smartphone, and a tablet terminal, and the user terminal 16 requests the image processing device 14 to transmit data by executing a program by the CPU and presents the transmitted data to a user. The user terminal 16 includes an input unit or an operation unit for requesting the image processing device 14 to transmit data and has a display unit to present the data that has been transmitted from the image processing device 14, to the user.

FIG. 1 only shows one image capturing device 12 and one user terminal 16. However, many image capturing devices 12 and user terminals 16 may be connected to the image processing device 14 via the network 10. Alternatively, instead of providing the network 10, the image capturing device 12, and the user terminal 16, the image processing device 14 may include the image capturing device 12 and include a display unit which presents data to the user so that they are configured to realize the functions of the embodiment by the image processing device 14.

[Configuration of Deterioration-Area Calculating Program 24b]

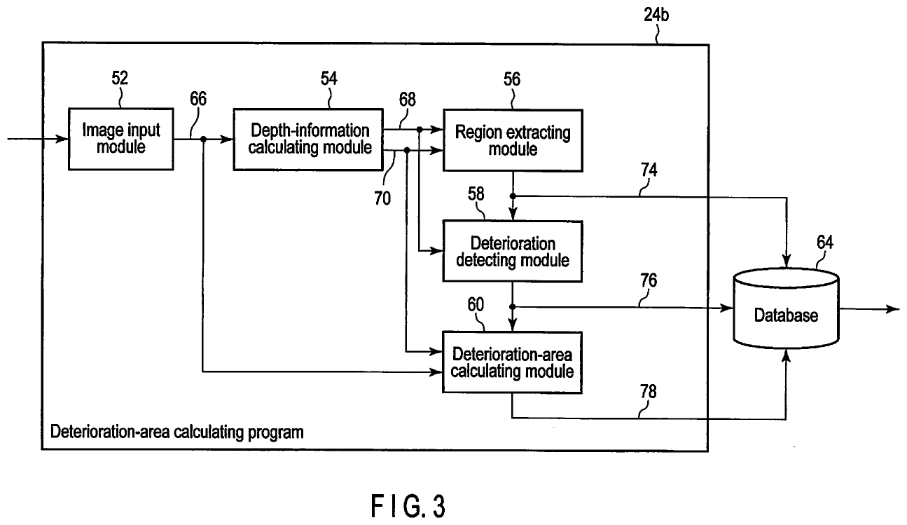

FIG. 3 shows an example of the configuration of a deterioration-area calculating program 24b executed by the processor 22 of the first embodiment. The deterioration-area calculating program 24b includes an image input module 52, a depth-information calculating module 54, a region extracting module 56, a deterioration detecting module 58, and a deterioration-area calculating module 60.

Image data 66 that is the image data transmitted from the image capturing device 12 and includes an image of an inspection object, is input to the deterioration-area calculating program 24b by the image input module 52. The data style of the image data 66 may be arbitrary. The data format of the image data 66 may also be arbitrary. The data format of the image data 66 may be a general data format such as BMP, PNG, or JPG or may be an original format designed by a camera vendor. The image data 66 includes optical camera parameters (focal length, camera sensor size, image size, etc.) in addition to a color image.

The depth-information calculating module 54 obtains the color image (hereinafter, referred to as a captured image) 68 and a depth image 70 from the image data 66. Since the image capturing device 12 uses the color aperture image capturing technique, the depth-information calculating module 54 can calculate depths based on the shapes of blurs of the image data 66 as shown in FIGS. 2A to 2C. The depth image 70 is generated from the depth information of pixels of the captured image 68. The depth-information calculating module 54 may have a function to carry out preprocessing on the captured image 68 and the depth image 70.

The preprocessing includes geometric transformation and a process of compensating for the variations in image data that are dependent on image capturing conditions. The geometric transformation includes changes in image sizes, trimming, rotation, parallel shift, etc. The process of compensating for the variations in the image data dependent on the image capturing conditions includes correction of brightness and contrast, dynamic range transformation, hue correction, etc. The preprocessing has been described as a function included in the depth-information calculating module 54. However, similar preprocessing may be carried out by another module such as the image input module 52 or the region extracting module 56. The variations in sizes, brightness, etc., of the image data can be normalized to standardize input data by the preprocessing. If the normalization process is carried out in a later stage instead of carrying it out in the preprocessing stage, a processing unit of the later stage has to be provided in two types, i.e., for the case where the normalization has been finished and the case where the normalization has not been carried out. However, the processing unit of the later stage can be commonized by carrying out the normalization process in the preprocessing stage.

When the region extracting module 56 receives the captured image 68 and the depth image 70, the region extracting module 56 extracts the region in which the inspection object is captured from the captured image 68 and generates an extracted image 74. The extracted image 74 is an image of the extracted region. If the inspection object is a steel tower, the region extracting module 56 extracts the image in which only the steel tower is captured. The buildings, scenery, etc., captured in background are not extracted by the region extracting module 56. A method to generate the extracted image 74 in the region extracting module 56 will be described later.

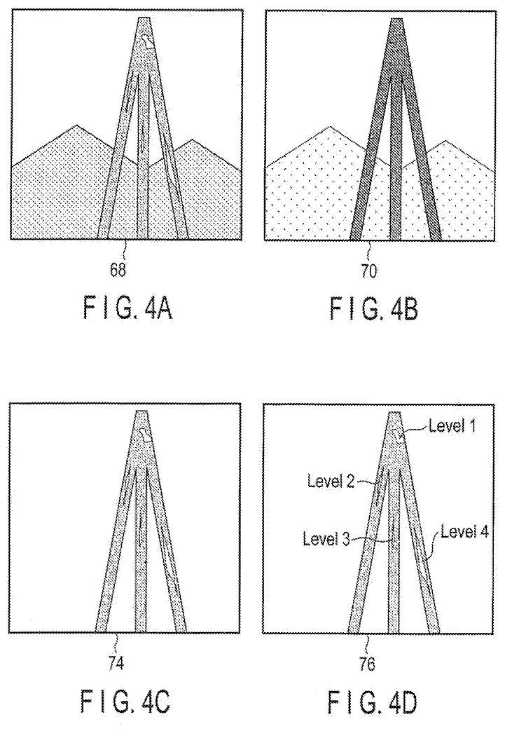

FIGS. 4A and 4B show examples of the captured image 68 and the depth image 70 input to the region extracting module 56. The captured image 68 shows the example of an inspection system of steel towers that suspend power lines. The image of a steel tower is captured outdoors. The image capturing device 12 may include a telescopic lens to capture images of the distant steel tower from ground. The image capturing device 12 may be installed in an air vehicle such as a drone to capture images of the steel tower at close range. FIG. 4A shows the captured image 68 capturing the steel tower that is the inspection object, on the near side and capturing mountains on the far side. The captured image 68 may be expressed in colors, and the expressing method of the depth image 70 may be colors or grayscale.

Pixel values of the depth image 70 correspond to the depths of pixels. In this case, if the depth of a pixel is large (or the inspection object is far), the pixel value is large. If the depth of a pixel is small (or the inspection object is near), the pixel value is small. Therefore, as shown in FIG. 4B, the sky at an infinite distance is expressed by white, the mountains that are backgrounds, are expressed by gray, and the steel tower at a closest distance is expressed by dark gray. However, oppositely, the depth image 70 may be configured so that the deeper the depth of the pixel (the farther), the lower the pixel value, and the shallower the depth (the closer), the higher the pixel value.

FIG. 4C shows an example of the extracted image 74 that is output from the region extracting module 56. The extracted image 74 is an image capturing only the steel tower that is the inspection object in the captured image 68. Inspection objects may be deteriorated in some cases, and the inspection object included in the extracted image 74 may include deteriorated regions. In FIG. 4C, deteriorated regions are shown by replacing the colors of the regions with white for the sake of convenience.

The deterioration detecting module 58 detects predetermined regions of the inspection object captured in the extracted image 74. The predetermined regions are not limited to partial regions, but may be the entire region of the inspection object. In this case, the predetermined regions will be described as deteriorated regions. The deterioration detecting module 58 detects the deterioration levels of the images of the deteriorated regions in the inspection object included in the extracted image 74 by utilizing color samples about the deterioration levels of each of deterioration items and creates the deterioration image 76 showing the deterioration level of each of the deteriorated regions. The deterioration items may include the deterioration items during manufacturing/construction of the inspection object and the deterioration items after the construction. The deterioration items during manufacturing/construction may correspond to discrepancies between a design and an actual object and include, for example, tilting, missed welding, missed coating, missed bolts or nuts, etc. The deterioration items after construction may correspond to aging deterioration and, for example, may include rust, corrosion, coating detachment, irregularities, damage, discoloring, etc.

For the deterioration item such as rust, approximate colors are determined depending on the type of coating performed on the inspection object. For example, according to document 1 (Ryuichi Ishino et al., “Image Processing Techniques for Selection of Aging Towers to be Painted -Support Tool using an Aerial Image of a Transmission Tower for Decision of Deteriorating Level for the Tower-”, CRIEPI Research Report (No. C17013), June 2018), rust color samples of steel towers are defined by four or five grades. In order to determine rust deterioration, the color information of rust of steel towers corresponding to deterioration levels have been collected, and a color information database has been created. The color information database and captured images are compared with each other, and the deterioration levels are determined based on the comparison results.

As the method to determine deterioration levels from images, various methods have been proposed. For example, there are proposed a method using machine learning which uses a color pattern, etc., as feature amounts and a method using deep learning which uses data sets of collected images and deterioration levels. The document 1 teaches a method in which captured images are subjected to mapping in HSV color space to carry out threshold processing within the possible ranges of color samples corresponding to deterioration levels determined in advance.

The deterioration detecting module 58 of the embodiment is only required to be able to detect the deterioration level for each of the deterioration items, and an arbitrary method can be used as a specific approach therefor. The simplest method to determine the deterioration level is a method that uses a discriminator that discriminates whether or not the unit part of the inspection object corresponding to each pixel of the extracted image 74 is deteriorated by binary based on the pixel value of each pixel. The embodiment can utilize this method.

FIG. 4D shows an example of the deterioration image 76 output from the deterioration detecting module 58. The deterioration detecting module 58 extracts a deteriorated region about one deterioration item (for example, rust) included in the extracted image 74. The deterioration detecting module 58 subjects the pixel values of the rust region to discrimination processing in accordance with deterioration levels. The deterioration detecting module 58 expresses segmentation results that are the discrimination results sorted in four grades in accordance with the deterioration levels, by different colors (for example, red, blue, yellow, and green) respectively corresponding to the deterioration levels and generates the deterioration image 76. For example, the deterioration of level 1 is shown in red, the deterioration of level 2 is shown in blue, the deterioration of level 3 is shown in yellow, and the deterioration of level 4 is shown in green. Level 4 means that it is most deteriorated, and level 1 means that it is least deteriorated. The deterioration detecting module 58 can output a plurality of deterioration images 76 about a plurality of deterioration items. FIG. 4D shows the deterioration image 76 about rust.

In the example of the deterioration image 76 in FIG. 4D, the segmentation results that are the deteriorated regions, are expressed in a superimposed manner on the extracted image 74 in order to facilitate understanding. However, only the segmentation results may be shown without showing the extracted image 74, or the segmentation results may be shown in a superimposed manner on a sparse point group expression instead of the extracted image 74.

The deterioration-area calculating module 60 obtains optical parameters (focal length, sensor size of the camera, image size, etc.) that are determined based on an optical model of the camera, from the image data 66. The deterioration-area calculating module 60 obtains the areas of the deteriorated regions that are included in the deterioration image 76 of each of the deterioration items, for each of the deterioration levels by using the optical parameters and the depth image 70, and outputs deterioration-area data 78. The deterioration levels are the above-described levels of rust defined in four grades and are herein expressed as rust deterioration levels. A method to calculate the areas of the deteriorated regions will be described later.

The deterioration-area calculating module 60 calculates the actual physical area (hereinafter, referred to as a pixel area) of the unit part of the inspection object corresponding to each pixel and creates an area map showing the pixel area for each of the pixels. All the pixels in the image have the same size, but the pixel areas of the plurality of pixels having different distances to objects are different. The deterioration-area calculating module 60 totalizes the pixel areas in the deteriorated regions of each of the deterioration levels based on the area map and the deterioration image 76, thereby generating the deterioration-area data 78. The deterioration-area data 78 shows the area of the deteriorated regions of each of the deterioration levels. If it can be assumed that the pixel areas of the pixels are the same, the deterioration-area may be obtained simply by multiplying the pixel area by the number of pixels of the deteriorated regions. It has been described that the pixel areas corresponding to all the pixels are calculated when the area map is created. However, the calculation of the pixel area of the inspection object may be omitted for the part excluding the deteriorated part since the ultimately required area is the area of the deteriorated part in the deterioration image 76.

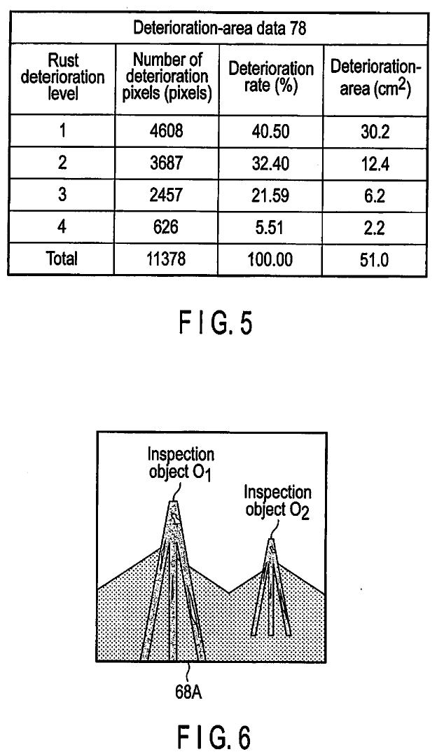

FIG. 5 shows an example of the deterioration-area data 78 output from the deterioration-area calculating module 60. The deterioration-area data 78 includes the number of deterioration pixels, deterioration rate, deterioration-area, and totals of the deterioration pixels and deterioration-areas corresponding to each of the rust deterioration levels 1 to 4. The number of deterioration pixels is calculated from the deterioration image 76. The deterioration rate is the rate of the deterioration pixels of the corresponding level to all the deterioration pixels. The deterioration-area can be calculated by the deterioration-area calculating module 60. The number of deterioration pixels and the deterioration rate calculated from the deterioration image 76 are not the physical deterioration-area on the actual inspection object.

FIG. 6 shows another example of the captured image. A captured image 68A includes two inspection objects O₁ and O₂ that have the same rust deterioration level and physical area, but are at different distances from the camera. In this case, the inspection object O₁ is at a position closer than the inspection object O₂.

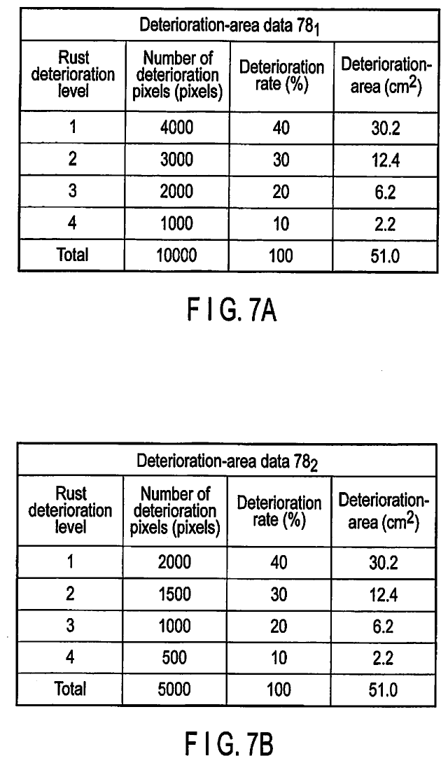

FIGS. 7A and 7B show examples of deterioration-area data 78₁ and 78₂ of the inspection objects O₁ and 0₂, respectively. The number of deterioration pixels in the deterioration-area data 78₁ of the inspection object O₁ is different from the deterioration-area data 78₂ of the inspection object O₂. However, since the rust deterioration levels and the deterioration-areas of the two inspection objects are the same, the deterioration diagnosis results of the two inspection objects should be the same even if the distances are different. Since the deterioration-areas are physical quantities calculated from the actual physical sizes of the inspection objects, the deterioration-areas of the two inspection objects are the same. It is preferred to be based on physical areas when the deterioration levels of inspection objects that are important in inspections, are to be judged. As described in the embodiment, the image processing device 14 of the embodiment capable of calculating the actual physical deterioration-areas of inspection objects by the deterioration-area calculating module 60 without depending on the distances or the like to the inspection objects is useful.

Returning to description about FIG. 3, the extracted image 74 output from the region extracting module 56, the deterioration image 76 output from the deterioration detecting module 58, and the deterioration-area data 78 output from the deterioration-area calculating module 60 are stored in a database 64. The database 64 may be formed by the main storage device 24. If the main storage device 24 is formed by a DRAM, the data in the database 64 is copied to the non-volatile auxiliary storage device 26 before the power of the main storage device 24 is turned off. Alternatively, the database 64 may be provided on the network 10, separately from the image processing device 14. Furthermore, the captured image 68 and the depth image 70 may be also stored in the database 64.

In response to a request from the user terminal 16, the data in the database 64 is read, is transmitted to the user terminal 16, and is presented to the user in the form corresponding to the request. For example, if a request to acquire the deterioration-area data 78 or various images 74, 76, etc., is transmitted to the image processing device 14 from the user terminal 16 through the Web or the like, required data is transmitted from the database 64 to the user terminal 16 via Web API or the like as a response thereto. Requests and responses may be implemented by, for example, Rest API or the like that is known in a web application.

When the system of FIG. 1 is applied to an inspection system, a person in charge of inspection captures an image of an inspection object by using the image capturing device 12 and uploads the image data to the image processing device 14. The image processing device 14 calculates deterioration-areas and stores the deterioration-areas in the database 64. A person in charge of repair may transmit a download request of the deterioration-area, etc., from the user terminal 16 to the image processing device 14, check the deterioration-area, etc., by the display unit of the user terminal 16, and create a repair schedule.

[Processing Flow of Deterioration-Area Calculating Program 24b]

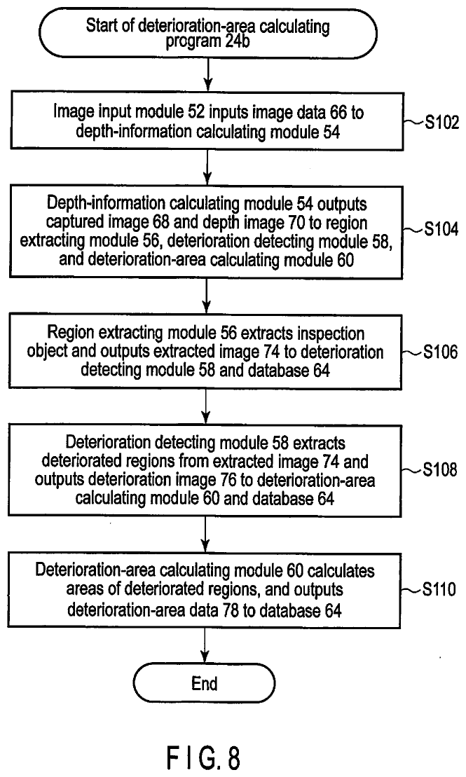

FIG. 8 is a flow chart showing an example of the processing of the deterioration-area calculating program 24b .

The image processing device 14 is in a standby state until a deterioration diagnosis request comes in from outside. When the deterioration diagnosis request comes in from outside, the image processing device 14 activates the deterioration-area calculating program 24b . When the deterioration-area calculating program 24b starts, the image input module 52 inputs the image data 66 from the image capturing device 12 to the depth-information calculating module 54 in step S102. If the image capturing device 12 or the image processing device 14 is not always connected to the network 10, the network 10 may be provided with another storage device. The image data 66 transmitted from the image capturing device 12 may be once stored in the storage device, and the image processing device 14 may transmit a transmission request of the image data to the storage device.

After step S102, the depth-information calculating module 54 outputs the captured image 68 and the depth image 70 to the region extracting module 56, the deterioration detecting module 58, and the deterioration-area calculating module 60 in step S104.

After step S104, the region extracting module 56 extracts an inspection object(s) from the captured image 68 and outputs the extracted image 74 to the deterioration detecting module 58 and the database 64 in step S106.

After step S106, the deterioration detecting module 58 extracts deteriorated regions from the extracted image 74 and outputs the deterioration image 76 to the deterioration-area calculating module 60 and the database 64.

After step S108, the deterioration-area calculating module 60 calculates the pixel area of the depth image 70 based on optical parameters (focal length, camera sensor size, image size, etc.) of the camera included in the image data 66. The deterioration-area calculating module 60 totalizes the pixel areas of the plurality of deteriorated regions in the deterioration image 76 corresponding to the deterioration levels to calculate the areas of the deteriorated regions. The deterioration-area calculating module 60 outputs the deterioration-area data 78 to the database 64 in step S110.

As described above, the deterioration-area data 78, the deterioration image 76, and the extracted image 74 are stored in the database 64 because of executing the deterioration-area calculating program 24b . The deterioration-area data 78, the deterioration image 76, and the extracted image 74 stored in the database 64 are read from the database 64 in response to an external request, and the data satisfying the request is provided in the form satisfying the request when the response is returned.

Next, details of the modules of the deterioration-area calculating program 24b will be described.

[Region Extracting Module 56]

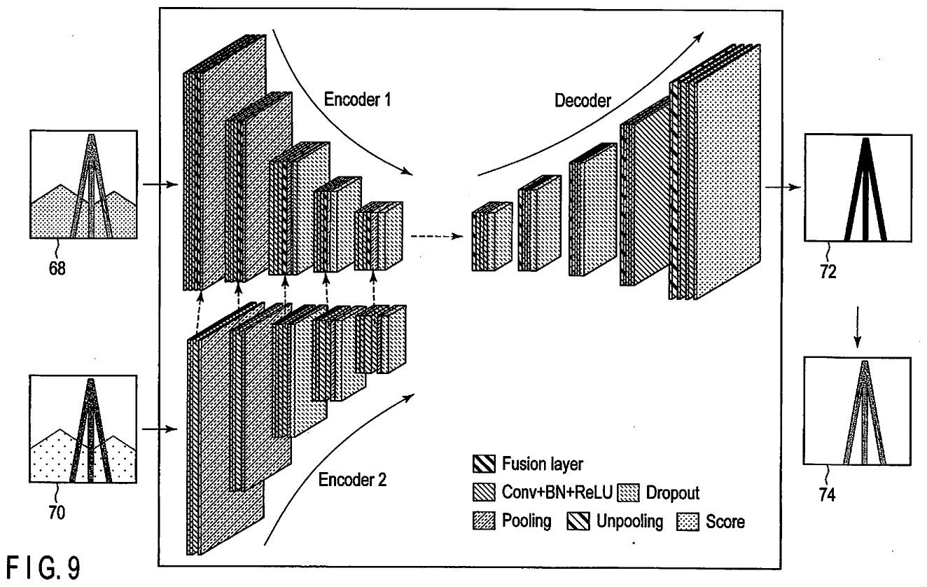

With reference to FIG. 9, an example of specific processing of the region extracting module 56 will be described. As an example of estimation processing by a machine learning method carried out by the region extracting module 56, FIG. 9 shows an example of a deep learning model with two encoders in order to handle a plurality of inputs. Input data is the captured image 68 and the depth image 70, and output data is a likelihood image 72 showing the probabilities that the pixels of the depth image 70 are the pixels in the region showing a photographic subject of the inspection object. A deep learning model is formed by carrying out learning in advance by using a plurality of learning data sets, in which input data and a supervised likelihood image constitute each set. The structure of an auto-encoder type that is generally used in a segmentation task, is shown as an example of the deep learning model.

The deep learning model of FIG. 9 includes an encoder part and a decoder part. The encoder part includes “Cony (Convolution) layer+BN (Batch Normalization) layer+ReLU (Rectified Linear Units) layer”, a Pooling layer, a Dropout layer, etc. The decoder part includes an Unpooling layer, “a Conv+BN+ReLU layer”, a Dropout layer, a Score layer, etc.

The network structure may be changed by expanding the above described network structure, increasing the number of channels with respect to the number of input data, further deepening the layer structures, deleting the Dropout layer, or connecting the same structure in a recurrent manner. In addition, the part corresponding to the encoder of the network may be increased by the number of input data to add fusion layers that combine the feature amounts of encoders, between layers. Furthermore, the auto-encoder structure is not limited to the above-described structure, but may be a network structure that has a connected layer that reuses the encoder-side output of the same hierarchical level by the decoder side, in addition to the above-described plurality of input data. Such a network structure that maintains a high resolution feature is known as a U-net structure. When a network is learned by using deep learning that extracts only the inspection objects serving as targets, with respect to such a model, the objects can be extracted from images with high precision.

Generally, the captured image 68 is subjected to learning so that the inspection object is extracted by using the shape pattern of the image, the color signal pattern of color space, etc., as features. However, for example in a case where the colors of the inspection object and background are similar in the original image, extraction precision may be decreased. On the other hand, the depth image 70 is subjected to learning so that the inspection object is extracted after the distance pattern included in the image is used as a feature instead of shape pattern or color pattern. Therefore, high precision extraction of the inspection object that is difficult only by the captured image 68, can be carried out since the deep learning model inputs these different images and extracts the inspection object by combining the two images.

The likelihood image 72 output from the deep learning model is subjected to a binarization by threshold processing or the like, and the region in which likelihood is higher than the threshold is separated from the captured image 68 to generate the extracted image 74.

The region extracting module 56 is not limited to model based estimation, but may employ statistically based estimation processing.

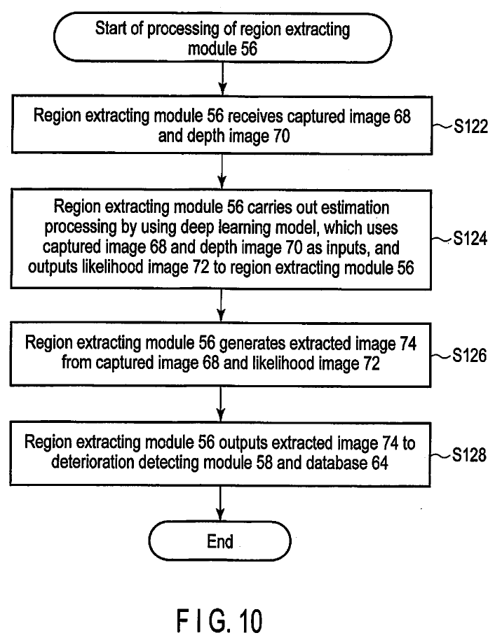

FIG. 10 is a flow chart showing an example of the processing flow of the region extracting module 56. The depth-information calculating module 54 outputs the captured image 68, and the region extracting module 56 outputs the extracted image 74. Then, in step S122, the region extracting module 56 receives the captured image 68 and the depth image 70. In step S124, the region extracting module 56 carries out estimation processing by using the deep learning model that uses the captured image 68 and the depth image 70 as inputs, and outputs the likelihood image 72 to the region extracting module 56. In step S126, the region extracting module 56 generates the extracted image 74 from the captured image 68 and the likelihood image 72. In step S128, the region extracting module 56 outputs the extracted image 74 to the deterioration detecting module 58 and the database 64. Then, the region extracting module 56 becomes a standby state.

### [Deterioration Detecting Module 58]

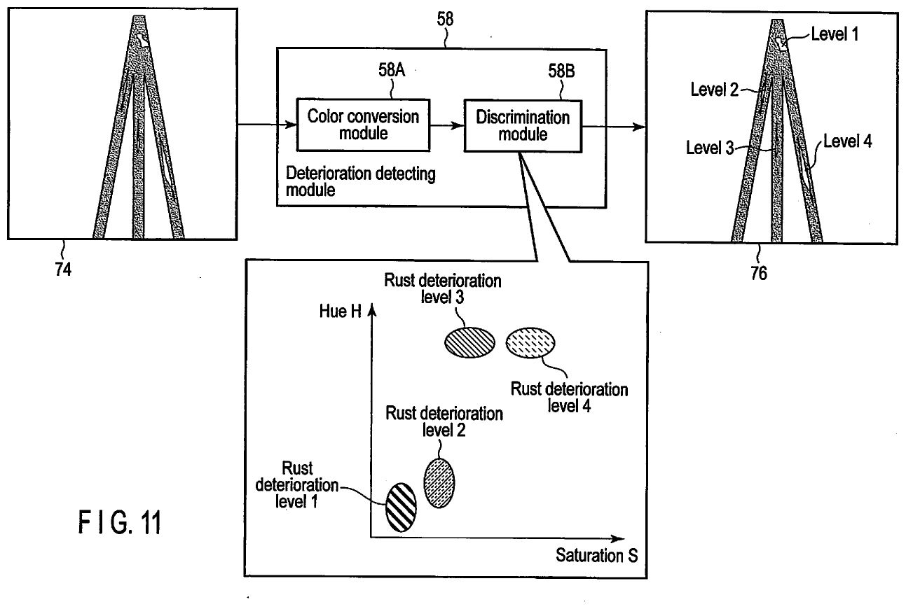

With reference to FIG. 11, a specific processing flow of the deterioration detecting module 58 will be described. FIG. 11 shows an example of an image processing method carried out by the deterioration detecting module 58. The deterioration detecting module 58 includes a color conversion module 58A and a discrimination module 58B.

The color conversion module 58A has a function to convert the extracted image 74 (RGB spatial signals) to HSV spatial signals and a function to correct colors. Generally, the signals of RGB space and HSV space can be mutually converted. The correction of colors is carried out by using color samples of each of inspection objects. For example, part of an inspection object (tip part, terminal part, or the like) is selected and compared with the color samples, and color correction is carried out so that the extracted image 74 matches the color samples. If the inspection object is, for example, a steel tower, an insulator or the like which is not easily affected by colors but is the part having shapes characteristic to steel towers may be selected as the part to be compared with the color samples of the steel tower. Conventionally, various methods have been proposed for the color matching between images, and any method may be used. Correction may be carried out in RGB space or may be carried out in HSV space. As an example, the color correction may be carried out by subjecting three color signals in RGB space to function fitting. The preprocessing as described for the depth-information calculating module 54 may be applied to the color correction.

The extracted image 74 that has undergone conversion and color correction in the color conversion module 58A, is input to the discrimination module 58B. In the discrimination module 58B, discrimination processing is carried out to locate the hue H and saturation S of each pixel of the extracted image 74 on a sorting map by using the sorting map of the hue H, the saturation S, and the rust deterioration levels defined in advance. The discrimination processing is carried out by determining the rust deterioration levels based on a color database, in which many color samples are stored. Because of subjecting each of the pixels to the discrimination processing for each of the deterioration item, the deterioration image 76, in which deteriorated regions are expressed by different colors depending on the deterioration levels, is generated for each of the deterioration item. The region excluding the deteriorated regions is configured to be transparent.

The example in which extremely simple discrimination processing is carried out has been described in this case. However, a deep learning model may be learned by using deep learning with preparation of a plurality of data sets of extracted images and supervised deterioration images. As the network used in this case, a network of an auto-encoder type as described above may be used, or a simpler fully connected network, VGG, ResNet, DenseNet, or the like may be also used. When a latest deep network structure is used, the expressing power of the model is enhanced, and improvement in discrimination performance can be expected.

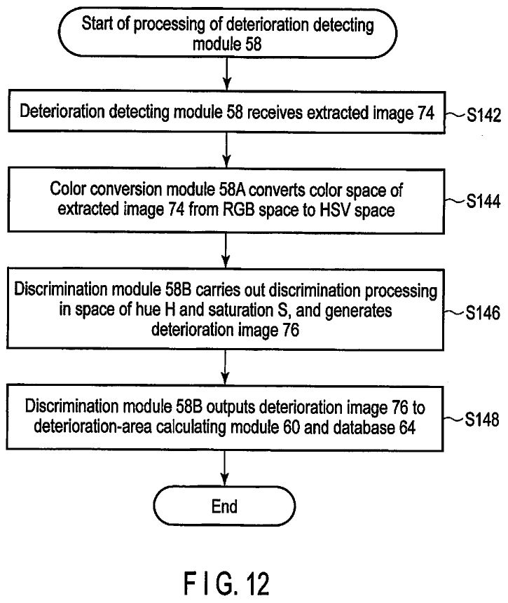

FIG. 12 is a flow chart showing an example of the processing flow of the deterioration detecting module 58. After the region extracting module 56 outputs the extracted image 74, the deterioration detecting module 58 receives the extracted image 74 in step S142. In step S144, the color conversion module 58A converts the color space of the extracted image 74 from RGB space to HSV space and carries out color correction corresponding to the inspection object. In step S146, the discrimination module 58B carries out discrimination processing of the extracted image 74 by using the sorting map in the space of the hue H and the saturation S and generates the deterioration image 76 for each of the deterioration items. In step S148, the discrimination module 58B outputs the deterioration image 76 to the deterioration-area calculating module 60 and the database 64. Then, the deterioration detecting module 58 becomes a standby state.

[Deterioration-area calculating module 60]

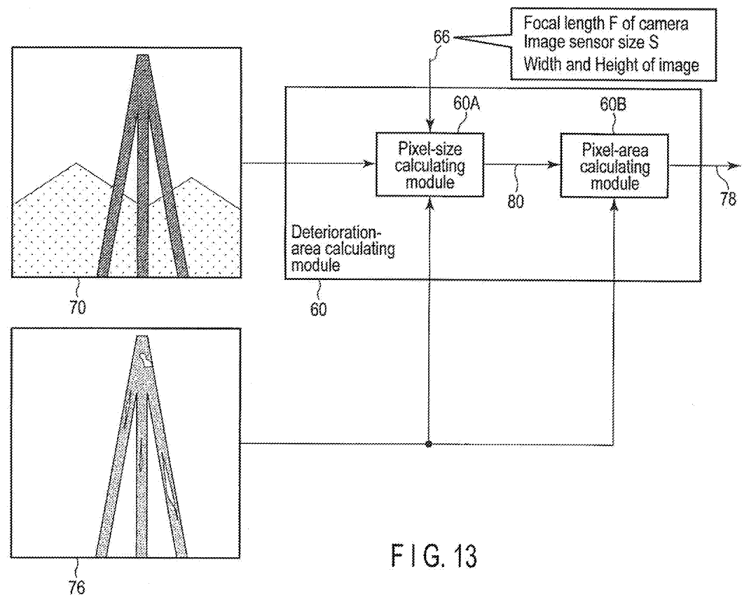

With reference to FIG. 13, a specific processing flow of the deterioration-area calculating module 60 will be described. FIG. 13 shows an example of an area calculating method carried out by the deterioration-area calculating module 60. The deterioration-area calculating module 60 includes a pixel-size calculating module 60A and a pixel-area calculating module 60B.

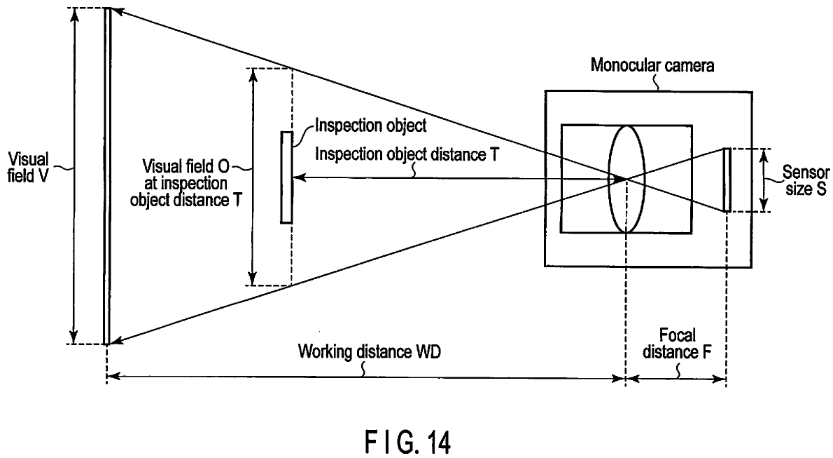

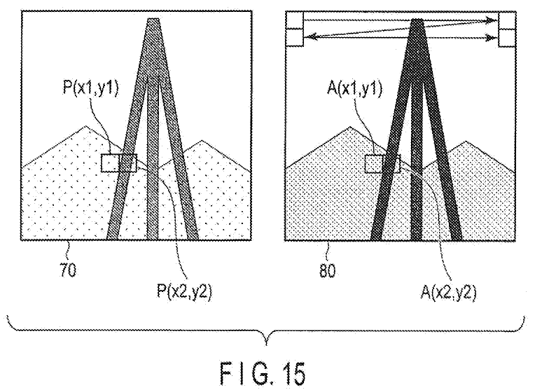

The pixel-size calculating module 60A has functions: to receive a focal length F of camera, a sensor size S of the image sensor, and “Width” and “Height” of the image that are optical parameters of the camera included in the image data 66; to receive the depth image 70; to calculate, for each pixel of the depth image 70, the actual physical size (width and height) (also referred to as a pixel size) of the unit part of the inspection object corresponding to the pixel; and to calculate the pixel area from the width and the height. FIG. 14 shows principles to calculate the actual physical size of the unit part of the inspection object corresponding to each pixel and calculate the pixel area by using the distance between the lens of the camera and the inspection object (distance T to the inspection object).

The pixel-size calculating module 60A receives the focal length F of the camera, the sensor size S of the image sensor, the “Width” and “Height” of the image from the image data 66. The sensor size S includes an x-direction component Sx (width) and a y-direction component Sy (height). FIG. 14 shows the size in the y direction. The x direction is the direction orthogonal to the paper surface of FIG. 14. Since the sensor size S can be set in advance by the camera to be used, the sensor size may be a variable defined in the deterioration-area calculating program 24b instead of receiving the sensor size from the image data 66. A visual field V varies depending on the lens used to capture images. The visual field V also includes an x-direction component Vx and a y-direction component Vy. The distance to the visual field V is called a working distance WD. The working distance WD, the visual field Vx, Vy, the focal length F, and the sensor size Sx, Sy satisfy following relational equations.

WD:Vx=F:Sx Equation 1

WD:Vy=F:Sy Equation 2

Similarly, the distance T to the inspection object, a visual field Ox, Oy at the inspection object distance T, the focal length F, and the sensor size Sx, Sy also satisfy following relational equations.

T:Ox=F:Sx Equation 3

T:Oy=F:Sy Equation 4

The focal length F and the sensor size Sx, Sy of the camera are already known, and the distance T to the inspection object can be calculated from the depth image 70. Therefore, the visual field Ox, Oy at the inspection object distance T can be calculated by following equations.

Ox=T×Sx/F Equation 5

Oy=T×Sy/F Equation 6

When the visual field Ox at the inspection object distance T is found out, the actual physical width Dx of the unit part of the inspection object corresponding to one pixel of the image is calculated from the “Width” of the image by a following equation. The “Width” is the number of pixels of the sensor in the x direction.

Dx=Ox/“Width” Equation7

Similarly, when the visual field Oy at the inspection object distance T is found out, the actual physical height Dy of the unit part of the inspection object corresponding to one pixel of the image is calculated from the “Height” of the image by a following equation. The “Height” is the number of pixels of the sensor in the y direction.

Dy=Oy/“Height” Equation 8

The pixel size that is the actual physical width and height, of the unit part of the inspection object corresponding to one pixel is calculated by Equation 7 and Equation 8.

In the above-described description, it is assumed that the image of the inspection object is captured in a state in which the center thereof matches the center of the visual field V. If the center of the inspection object does not match the center of the visual field V, the pixel size expressed by Equation 7 and Equation 8 includes misalignment in an angular direction. However, since this misalignment depends on the optical system of the lens, it can be corrected in accordance with various numerical values of the optical system of the lens.

When the width and height of each unit part of the inspection object are calculated by Equation 7 and Equation 8, the pixel area that is the actual physical area of each unit part, is calculated by a following equation.

Axy=Dx×Dy Equation 9

The actual physical area of the deteriorated region of the inspection object can be calculated by totalizing the pixel areas of the pixels included in the deteriorated region in the image of the inspection object.

Returning to description about FIG. 13, the pixel-size calculating module 60A calculates the pixel area of each pixel by Equation 9 to generate an area map 80 as shown in FIG. 15. The area map 80 is a table showing the pixel area A(x, y) of each pixel P(x, y). The pixel-size calculating module 60A calculates Equation 1 to Equation 9 for a pixel P(0, 0) to calculate the pixel area A(0, 0) of the pixel P(0, 0). Then, the pixel-size calculating module 60A calculates Equation 1 to Equation 9 for a next pixel P(1, 0) to calculate the pixel area A(1, 0) thereof. Thereafter, similarly, the pixel-size calculating module 60A scans remaining pixels and calculates the pixel area A(x, y) of each of the pixels. The pixel-size calculating module 60A carries out normalization by 0 to 255 to make all the pixel areas into images and generate the area map 80. For example, a pixel P(x1, y1) corresponds to a mountain that is away by a distance of 100 m, and a pixel P(x2, y2) corresponds to a steel tower as an inspection object that is away by a distance of 10 m. In this case, the pixel area A(x2, y2) of the pixel P(x2, y2) at the short distance is smaller than the pixel area A(x1, y1) of the pixel P(x1, y1) at the long distance. The pixel area corresponding to the region such as the sky at which the distance T is the infinite distance is infinite. Since the infinite pixel area has a maximum value of 255, the region such as the sky at which the distance T is the infinite distance is expressed by a white pixel in the area map 80.

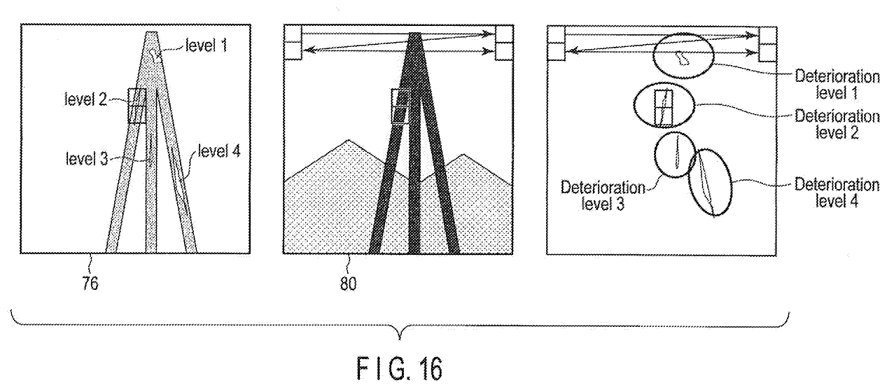

The area map 80 output from the pixel-size calculating module 60A is input to the pixel-area calculating module 60B. The deterioration image 76 is also input to the pixel-area calculating module 60B. The pixel-area calculating module 60B calculates the areas of the deteriorated regions in each deterioration level as shown in FIG. 16 in accordance with labels that are shown by the deterioration image 76 and corresponding to the rust deterioration levels. First, the pixel-area calculating module 60B determines whether any one of the deterioration levels 1 to 4 is set for the pixel P(0, 0) of the deterioration image 76.

If any of the deterioration levels 1 to 4 is set, the pixel-area calculating module 60B counts the number of all the pixels for which that deterioration level (for example, the deterioration level 1) is set in the deterioration image 76, obtains the rate (deterioration rate) of the count value to the number of all the pixels, and totalizes the pixel areas of the pixels for which the corresponding deterioration level is set to obtain the deterioration-area of this deterioration level. If none of the deterioration levels 1 to 4 is set for the pixel P(0, 0), the pixel-area calculating module 60B does not carry out any processing. Then, the pixel-area calculating module 60B subjects a pixel P(1, 0) of the deterioration image 76 to execution of the same processing as the processing of the pixel P(0, 0). However, if the deterioration-areas of the deterioration level set for the pixels have already been totalized, the pixel-area calculating module 60B does not carry out any processing. Thereafter, similarly, the pixel-area calculating module 60B scans remaining pixels and calculates the deterioration-area data 78.

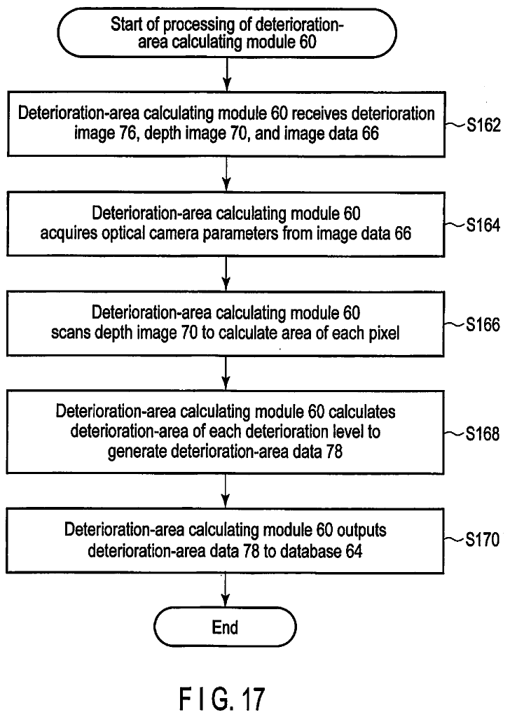

FIG. 17 is a flow chart showing an example of the processing flow of the deterioration-area calculating module 60. The depth-information calculating module 54 outputs the captured image 68, and the deterioration detecting module 58 outputs the deterioration image 76. Then, in step S162, the deterioration-area calculating module 60 receives the deterioration image 76, the depth image 70, and the image data 66. In step S164, the deterioration-area calculating module 60 (the pixel-size calculating module 60A) acquires optical parameters from the image data 66. The optical parameters may include the focal length F of the camera, the sensor size S of the image sensor, and the size of the image.

In step S166, as shown in FIG. 15, the deterioration-area calculating module 60 (the pixel-size calculating module 60A) scans the depth image 70, calculates the pixel area of each pixel, and generates the area map 80. As described above, since the ultimately required area is the area of the deteriorated regions in the deterioration image 76, the area map is not required to be created for the part excluding the deteriorated regions. Therefore, the pixel-size calculating module 60A may calculate the pixel areas based on the deterioration image 76 only for the region in which the inspection object is captured. In step S168, as shown in FIG. 16, the deterioration-area calculating module 60 (the pixel-area calculating module 60B) calculates the deterioration-area of each deterioration level based on the area map 80 and the deterioration image 76 to generate the deterioration-area data 78. In step S170, the deterioration-area calculating module 60 (the pixel-area calculating module 60B) outputs the deterioration-area data 78 to the database 64. Then, the deterioration-area calculating module 60 becomes a standby state.

### Outlines of First Embodiment

According to the first embodiment, the captured image 68 and the depth image 70 are generated from the image data 66 output from the image capturing device 12. The extracted image 74 including the inspection object(s) is generated from the captured image 68 and the depth image 70 by estimation processing. Whether or not each of the pixels of the extracted image 74 is deteriorated is discriminated for each deterioration level, the deteriorated regions of each deterioration level is extracted from the extracted image 74, and the deterioration image 76 is generated.

On the other hand, the pixel area that is the area of the unit part of the photographic subject corresponding to a pixel, is obtained for each pixel by using the depth image 70 and the optical parameters of the camera that has captured the image data. The pixel areas are totalized for the deteriorated regions of each deterioration level of the inspection object, and the deterioration-area of the deteriorated regions is obtained. The deterioration image 76 is generated for each deterioration item such as rust, corrosion, coating detachment, irregularities, damage, or discoloring. Therefore, the deterioration-area is obtained for each deterioration item and each deterioration level. The deterioration-area data 78 including the deterioration-area is stored in the database 64 and is transmitted to the user terminal 16 in response to a request from the user terminal 16. For example, when a person in charge of repair is to create a repair plan of inspection objects, the person in charge of repair requests the database 64 to transmit the deterioration-area data 78 of the inspection objects. The person in charge of repair can judge the degrees of deterioration of the inspection objects objectively in detail based on the deterioration-area data 78.

### Second Embodiment

The first embodiment has described the example using the image capturing device 12 that captures an image of a photographic subject based on the technique of the color aperture and outputs the image data to which the depth information is added. Therefore, the depth-information calculating module 54 of the deterioration-area calculating program 24b calculates the depth information from the image data. As a second embodiment, an example using another image capturing device will be described.

In the second embodiment, a monocular camera that acquires RGB color images, is used as the image capturing device, and depth information is obtained by another device. As an example to obtain the depth information, there is an example in which point group data of an inspection object is acquired by irradiating the inspection object with a laser beam from a position near a camera, and any of the data is corrected by calibration to acquire the depth information. Also as another example, there is an example in which the depth information is obtained by using a sensor of a TOF (Time Of Flight) measuring type. In the second embodiment, the image data and the depth information is obtained in the image capturing device side, and the image data and the depth information are supplied to an image processing device. The second embodiment is the same as the first embodiment except for the image capturing device 12 and the deterioration-area calculating program 24b.

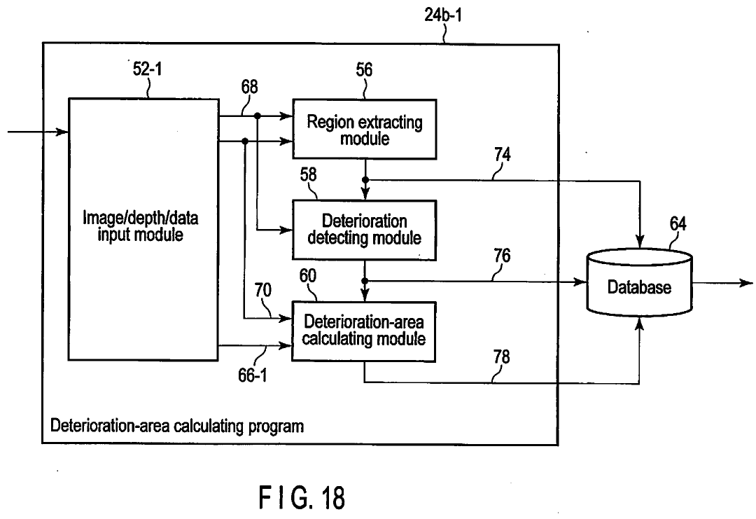

FIG. 18 shows an example of the configuration of a deterioration-area calculating program 24b-1 of the image processing device 14 of the second embodiment. The deterioration-area calculating program 24b-1 includes the region extracting module 56, the deterioration detecting module 58, and the deterioration-area calculating module 60 that are the same as those of the first embodiment. An image/depth/data input module 52-1 is provided instead of the image input module 52 and the depth-information calculating module 54 of the first embodiment.

The image/depth/data input module 52-1 inputs image data transmitted from an image capturing device (not shown), and depth information transmitted from a distance measuring device which is not the image capturing device. The image/depth/data input module 52-1 outputs the captured image 68 that is included in the input image data, to the region extracting module 56 and the deterioration detecting module 58; outputs the depth image 70 that is obtained from the input depth information, to the region extracting module 56 and the deterioration-area calculating module 60; and outputs optical parameters 66-1 that are included in the input image data, to the deterioration-area calculating module 60. Different from the first embodiment, the second embodiment is based on the outputs from the different devices, and, therefore, the captured image 68 and the depth image 70 may sometimes have different angles of view. In such a case, the region extracting module 56 enlarges the image that has a smaller angle of view so that the angles of view of the two images become equal to each other.

Other configurations are the same as those of the first embodiment.

### Third Embodiment

In the first and second embodiments, the deterioration-area data is calculated, and a person in charge of repair can judge the appropriateness of repair based on the sizes of deterioration-areas. In a third embodiment, repair priorities are calculated in addition to deterioration-area data.

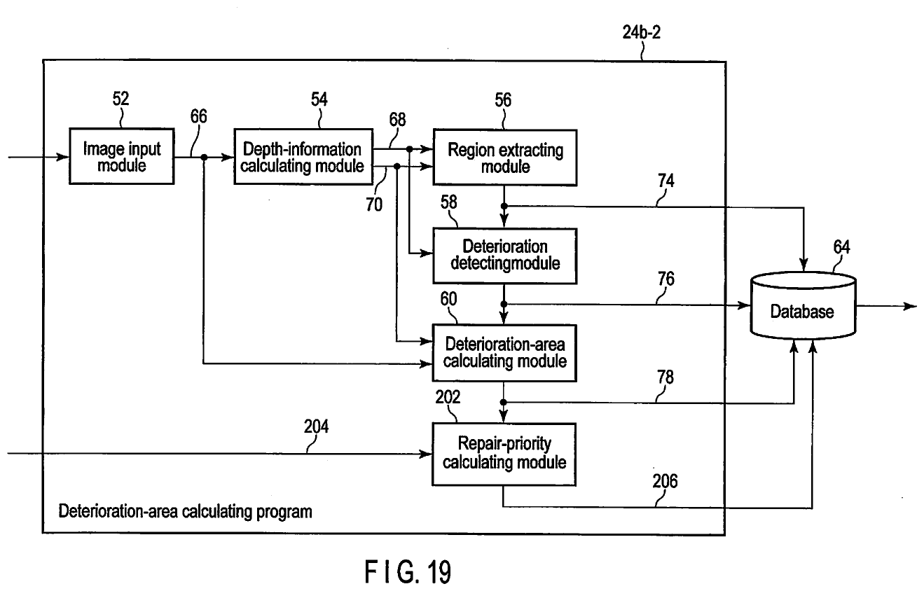

FIG. 19 shows a configuration example of a deterioration-area calculating program 24b-2 of the third embodiment, wherein a function to calculate the repair priorities is added to the first embodiment.

The deterioration-area calculating program 24b-2 includes a repair-priority calculating module 202 in addition to the deterioration-area calculating program 24b of the first embodiment.

Deterioration-area data 78 output from the deterioration-area calculating module 60 and repair data 204 are input to the repair-priority calculating module 202. The repair data 204 includes, for example, labels and inspection/repair histories of inspection objects. The labels of the inspection objects are indexes, unique names, or the like for specifying the plurality of inspection objects. The inspection/repair histories include information such as the number of times, time and date, locations, the deterioration level of each deterioration item, etc., of past inspections/repairs.

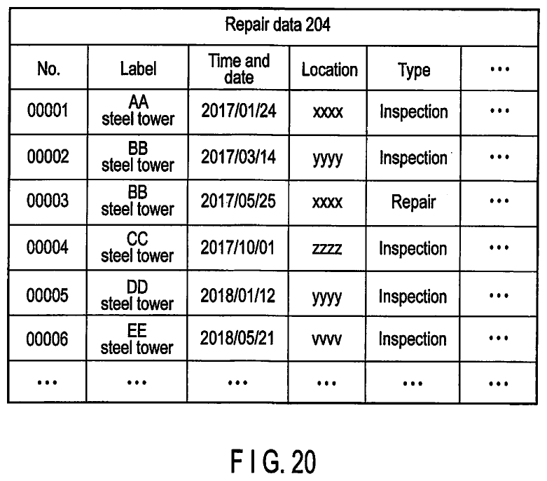

An example of the repair data 204 is shown in FIG. 20. “No.” represents indexes for specifying inspection objects. Label represents administration names of the inspection objects. Time and date represents the time and date of past inspection/repairs. Location represents repair locations. An example of the location is a 2-level part of a 5-level steel tower. Type represents work descriptions about, for example, whether the works carried out in the past are inspections or repairs. FIG. 20 shows the example including minimum information, but the repair data 204 may include administrative information other than the above data. For example, the repair data 204 may include the information of deterioration-area data 78 as shown in FIG. 5. By virtue of this, information such as the deterioration-area at the time of past inspections can be managed, and utilization for other applications such as predictions of rust deterioration-areas is enabled.

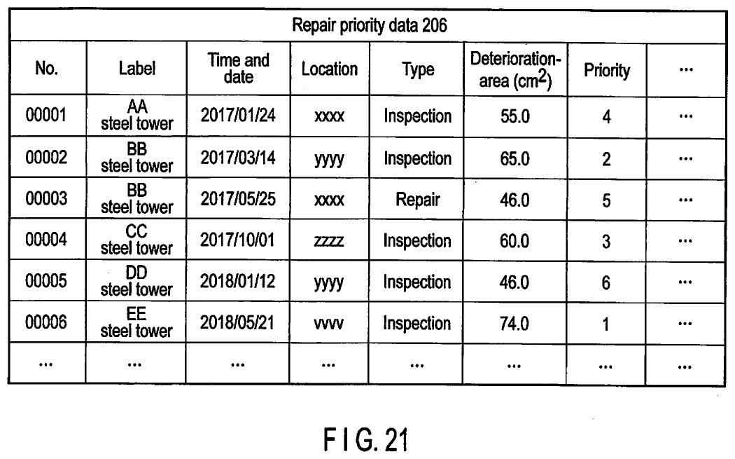

The repair-priority calculating module 202 associates the deterioration-areas of the deterioration-area data 78 of the inspection objects with the labels of the inspection objects included in the repair data 204 to create repair priority data 206 as a table in which repair histories and deterioration-areas are associated with each other. An example of the repair priority data 206 is shown in FIG. 21. Among the labels included in the repair data 204, high priorities (smaller numbers) are allocated to the labels for which the time and date of implementation is old and deterioration-area is large. In this process, the order of rearrangement may use the time and date as a primary key and the deterioration-areas as a sub-key or, oppositely, may use the deterioration-areas as a primary key and the time and date as a sub-key. FIG. 21 shows an example of the case that uses deterioration-areas as a primary key and time and date as a sub-key. The smaller the values of priorities, the more they are prioritized. The case of FIG. 21 shows that the repair of a label with No. 0006 having the largest deterioration-area is prioritized the most. The repair priority data 206 is output from the repair-priority calculating module 202 and input to the database 64.

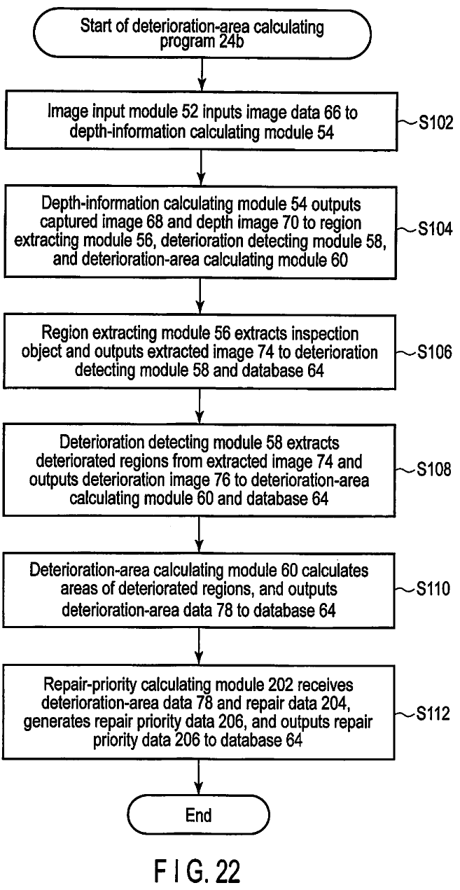

FIG. 22 is a flow chart showing an example of the processing of the deterioration-area calculating program 24b-2.

Step S102 to step S110 are the same as those of the flow chart of the deterioration-area calculating program 24b of the first embodiment shown in FIG. 8. The deterioration-area calculating module 60 outputs the deterioration-area data 78 in step S110. Then, in step S112, the deterioration-area data 78 and the repair data 204 are input to the repair-priority calculating module 202, and the repair-priority calculating module 202 generates the repair priority data 206 and outputs the repair priority data 206 to the database 64.

According to the third embodiment, a person in charge of repair can objectively judge the inspection object that is preferred to be preferentially repaired, and create an appropriate repair plan, by reading out the repair priority data 206 from the database 64. The person in

Although it is not shown in the drawings, an embodiment in which the function to calculate repair priorities is added to the second embodiment can be also implemented.

### MODIFICATION EXAMPLES

In the above-described embodiments, the functions are realized by executing the deterioration-area calculating programs 24b , 24b-1, and 24b-2 by the single processor 22. However, the embodiments may be configured to provide a plurality of processors so that the processors execute some modules of the programs. Furthermore, although deterioration-areas are calculated by executing the deterioration-area calculating program 24b , 24b-1, or 24b-2 by the processor 22, part or all of the modules of the deterioration-area calculating program 24b , 24b-1, or 24b-2 may be realized by hardware such as an IC. The operation mode of the image processing device 14 may be arbitrary. For example, the image processing device 14 may be operated as a cloud system on the network 10.

The areas of the deteriorated regions of an inspection object(s) are calculated in the embodiments. However, the regions for which areas are calculated are not limited to the deteriorated regions, but may be the whole inspection object(s). Furthermore, the embodiments may be configured to calculate the area of a particular photographic subject(s) in a screen instead of the inspection object. Therefore, the image processing device 14 of the embodiments can be applied to an arbitrary system other than a maintenance inspection system.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
one or more processors configured to
acquire a first image and an optical parameter of a camera which captures the first image, the first image including an object, and
calculate an area of a partial region of the object by using the first image and the parameter.

2. The image processing device according to claim 1, wherein the one or more processors are configured to detect the object by using depth information relating to the first image.

3. The image processing device according to claim 2, wherein the one or more processors are configured to detect the object by using a first feature amount relating to a shape pattern of the first image or a color pattern of the first image and a second feature amount relating to a depth pattern of the depth information.

4. The image processing device according to claim 2, wherein the one or more processors are configured to detect the partial region of the object.

5. The image processing device according to claim 4, wherein the one or more processors are configured to detect a deteriorated region of the object by using a correlation between the first image and a deterioration sample image.

6. The image processing device according to claim 2, wherein the one or more processors are configured to detect deteriorated regions of the object in a plurality of deterioration states, and calculate areas of the deteriorated regions.

7. The image processing device according to claim 6, wherein the one or more processors are configured to detect the deteriorated regions by using a correlation between the first image and deterioration sample images relating to the deterioration states.

8. The image processing device according to claim 6, wherein the deterioration states comprise at least one of a deterioration state during manufacturing or construction of the object and a deterioration state after manufacturing or construction of the object.

9. The image processing device according to claim 6, wherein the deterioration states comprise states relating to at least one of rust, corrosion, coating misalignment, coating detachment, an irregularity, damage, discoloring, design discrepancy, tilting, missed welding, missed coating, and a missed bolt or nut.

10. The image processing device according to claim 6, wherein the one or more processors are configured to calculate a repair priority of the deteriorated regions by using the areas of the deteriorated regions and past repair information.

11. The image processing device according to claim 10, wherein the repair priority becomes higher as the area of the deteriorated region that is in a first state of the deterioration state increases, and the repair priority becomes higher for older past repair timing.

12. The image processing device according to claim 2, wherein the one or more processors are configured to calculate an area of each unit part of the object corresponding to a pixel of the first image by using the optical parameter and the depth information.

13. The image processing device according to claim 12, wherein the one or more processors are configured to calculate the area of the each unit part by using a number of pixels of an image of the object and the area of the each unit part.

14. The image processing device according to claim 12, wherein the optical parameter comprises information relating to an optical model of the camera.

15. The image processing device according to claim 14, wherein the optical parameter comprises information relating to a sensor size and a focal length of the camera.

16. The image processing device according to claim 2, wherein the depth information comprises information relating to blur from a focal state of each color included in the first image.

17. An image processing method comprising:
acquiring a first image and depth information of each pixel of the first image, the first image including an object; and
calculating an area of a partial region of the object by using the first image and the depth information.
